(19) United States
(12) Patent Application Publication
(10) Pub. No.: US 2024/0140108 A1
(43) Pub. Date: May 2, 2024

(54) PRINTED MATTER PRODUCTION SYSTEM, PRINTING METHOD, AND NON-TRANSITORY COMPUTER-READABLE STORAGE MEDIUM STORING PRINTED MATTER PRODUCTION PROGRAM

(71) Applicant: SEIKO EPSON CORPORATION, Tokyo (JP)

(72) Inventors: Yuka KOBAYASHI, Shiojiri (JP); Ayako KOBAYASHI, Okaya (JP); Yuto FUKUCHI, Matsumoto (JP); Yuko ISHIFURO, Shiojiri (JP); Toshifumi SAKAI, Shiojiri (JP)

(21) Appl. No.: 18/494,799

(22) Filed: Oct. 26, 2023

(30) Foreign Application Priority Data
Oct. 28, 2022 (JP) 2022-173036

(51) Int. Cl. B41J 3/407; H04N 1/60

(52) U.S. Cl. CPC B41J 3/4073; H04N 1/6033

(57) ABSTRACT

A system includes: a reception unit that receives print settings; a production unit that causes a production device to form an image on a three-dimensional medium and produce printed matter based on the print settings; and a test unit that performs a test in which the image is applied to the medium or a test medium corresponding to the medium based on the print settings before forming the image on the medium to make a user determine whether or not the print settings are appropriate.

The present application is based on, and claims priority from JP Application Serial Number 2022-173036, filed Oct. 28, 2022, the disclosure of which is hereby incorporated by reference herein in its entirety.

### BACKGROUND

### 1. Technical Field

The present disclosure relates to a printed matter production system, a printing method, and a non-transitory computer-readable storage medium storing a printed matter production program.

### 2. Related Art

Hitherto, technologies for performing printing on various media have been known. For example, JP-A-2022-39737 discloses a printing device that prints an image on a can body.

There has been a demand for a technology that allows a user to easily imagine finished printed matter in advance when an image is formed on a three-dimensional medium.

### SUMMARY

According to an aspect of the present disclosure, a printed matter production system includes: a reception unit that receives print settings; a production unit that forms an image on a three-dimensional medium and produces printed matter based on the print settings; and a test unit that prints a two-dimensional full-sized test image of the image on a test paper sheet based on the print settings before forming the image on the medium.

According to an aspect of the present disclosure, a printed matter production method includes: receiving print settings; determining whether or not the print settings are appropriate by printing a two-dimensional full-sized test image of an image on a test paper sheet based on the print settings before forming the image on a three-dimensional medium and applying the test paper sheet on which the test image is printed to the medium; and forming the image on the medium and producing printed matter based on the print settings according to a determination result indicating that the print settings are appropriate.

According to an aspect of the present disclosure, a non-transitory computer-readable storage medium storing a printed matter production program causes a computer to function as: a reception unit that receives print settings; a test unit that prints a two-dimensional full-sized test image of an image on a test paper sheet based on the print settings before forming the image on a three-dimensional medium by printing based on the print settings; a determination unit that determines whether or not the print settings are appropriate by applying the test paper sheet on which the test image is printed to the medium; and a production unit that forms the image on the medium and produces printed matter based on the print settings according to a determination result indicating that the print settings are appropriate.

According to an aspect of the present disclosure, a printed matter production system includes: a reception unit that receives print settings; a production unit that forms an image on a three-dimensional medium and produces printed matter based on the print settings; and a projection unit that projects the image onto the medium based on the print settings before forming the image on the medium.

According to an aspect of the present disclosure, a printed matter production method includes: receiving print settings; projecting an image onto a three-dimensional medium based on the print settings before forming the image on the medium; determining whether or not the print settings are appropriate based on a projection result; and forming the image on the medium and producing printed matter based on the print settings according to a determination result indicating that the print settings are appropriate.

According to an aspect of the present disclosure, a non-transitory computer-readable storage medium storing a printed matter production program causes a computer to function as: a reception unit that receives print settings; a projection unit that projects an image onto a three-dimensional medium based on the print settings before forming the image on the medium; a determination unit that determines whether or not the print settings are appropriate based on a projection result; and a production unit that forms the image on the medium and produces printed matter based on the print settings according to a determination result indicating that the print settings are appropriate.

### BRIEF DESCRIPTION OF THE DRAWINGS

FIG. 1 is a block diagram of a printed matter production system.

FIG. 2 is a block diagram of a customer terminal.

FIG. 3 is a block diagram of a staff terminal.

FIG. 4 is a block diagram of a server.

FIG. 5 is a block diagram of a print control terminal.

FIG. 6 is a sequence diagram of printed matter production processing.

FIG. 7 is a sequence diagram of the printed matter production processing.

FIG. 8 is a view illustrating an example of an order reception screen.

FIG. 9 is a view illustrating an example of a screen for test printing.

FIG. 10 is a view illustrating an example of a screen for imaging.

FIG. 11 is a block diagram of a customer terminal according to another embodiment.

### DESCRIPTION OF EMBODIMENTS

Here, embodiments of the present disclosure will be described in the following order.

### 1. Configuration of Printed Matter Production System

### 1-1. Configuration of Customer Terminal

### 1-2. Configuration of Staff Terminal

### 1-3. Configuration of Server

### 1-4. Configuration of Print Control Terminal

### 2. Printed Matter Production Processing

### 3. Other Embodiments

### 1. Configuration of Printed Matter Production System

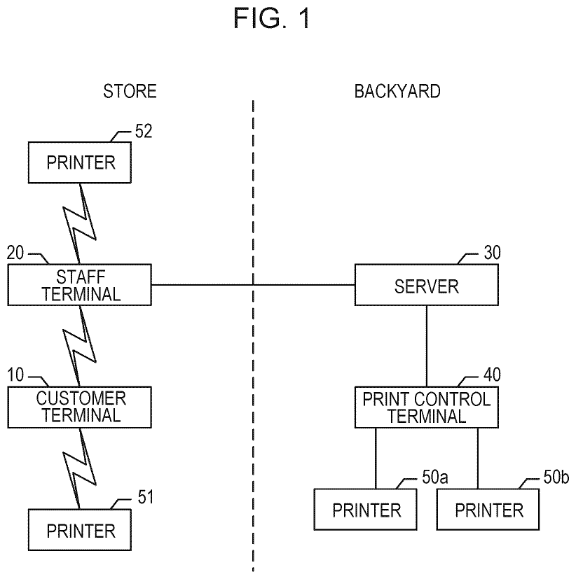

FIG. 1 is a diagram schematically illustrating an example of a printed matter production system according to an embodiment of the present disclosure. A printed matter production system 1 includes a customer terminal 10, a staff terminal 20, a server 30, and a print control terminal 40. A printer 51 is connected to the customer terminal 10, a printer 52 is connected to the staff terminal 20, and printers 50a and 50b are connected to the print control terminal 40, the printers 51, 52, 50a, and 50b being capable of performing printing according to instructions from the respective terminals. The number of devices illustrated is only an example, and the number of devices is not limited thereto. For example, the number of printers 50a and 50b indicated as being plural may be larger or smaller than the stated number. The number of customer terminals 10, the number of staff terminals 20, the number of printers 51, and the number of printers 52 indicated as being singular may be plural.

These devices can communicate with each other via a network. The network may have various aspects. For example, in the present embodiment, it is assumed that the customer terminal 10 communicates with the staff terminal 20 and the printer 51 in a wireless manner, and the staff terminal 20 communicates with the customer terminal 10 and the printer 52 in a wireless manner and communicates with the server 30 in a wired manner. However, the aspect of the network is not limited to this aspect.

In the present embodiment, the printed matter production system is used when producing printed matter according to an order from a customer. In the present embodiment, the customer terminal 10, the staff terminal 20, and the printers 51 and 52 are installed at a storefront where an order is received. On the other hand, the server 30, the print control terminal 40, and the printers 50a and 50b are installed in a backyard different from the storefront. The backyard may be a place connected to the storefront or a remote place such as a printing factory.

In the present embodiment, a customer places an order by using the customer terminal 10 installed at the storefront. A staff of the store uses the staff terminal 20 to confirm the order and receive payment. Printing data generated according to the order is transmitted to the server 30. The printing data is stored in the server 30, and the server 30 performs printing progress management related to the printing data. In the backyard, a printing operator performs printing according to the order from the customer by using the print control terminal 40.

The type of printed matter produced according to an order is not limited, and in the present embodiment, an example in which printed matter is produced by performing printing on a three-dimensional medium (a mug, a smartphone case, or the like) and a two-dimensional medium is assumed. Therefore, pieces of equipment capable of producing a three-dimensional medium and a two-dimensional medium are prepared as the printers 50a and 50b. The aspect of the printers 50a and 50b is not limited. Here, it is assumed that the printer 50a includes a sublimation transfer printer and a press machine for sublimation transfer of an image printed on sublimation transfer paper (for example, a mug press machine for transfer of an image to a surface of a cylindrical object such as a mug, or a press machine for transfer of an image to a surface of a smartphone cover). Formation of an image on a three-dimensional medium may be implemented by transfer as in the present embodiment, or an image may be directly printed using a robot arm or the like.

It is assumed that the printer 50b is a printer that performs printing on two-dimensional printing paper. In the present embodiment, the printers 51 and 52 are also printers that perform printing on two-dimensional printing paper. The printer 51 is, for example, a document printer that prints a receipt indicating an order number or the like for identifying an order from a customer, or a test image to be described below. The printer 52 is, for example, a document printer that prints an order form indicating order details for a customer.

Each device included in the above-described printed matter production system 1 will be described below.

### 1-1. Configuration of Customer Terminal

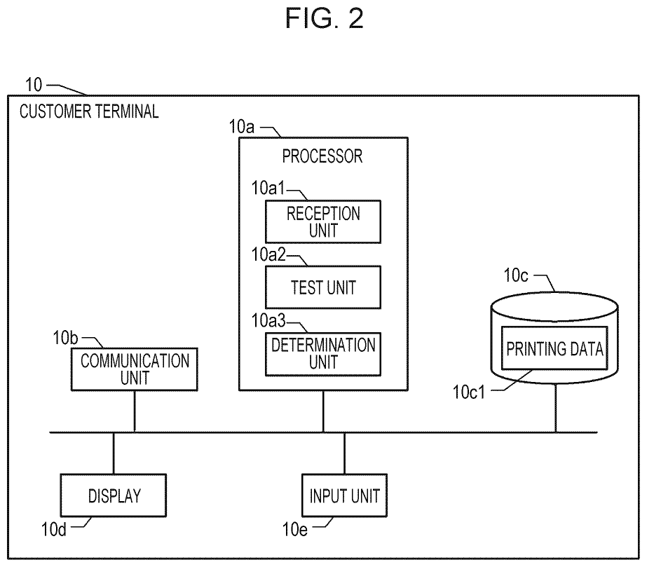

FIG. 2 is a block diagram illustrating a configuration of the customer terminal 10. The customer terminal 10 includes a processor 10a, a communication unit 10b, a non-volatile memory 10c, a display 10d, and an input unit 10e. The processor 10a includes a central processing unit (CPU), a read only memory (ROM), a random access memory (RAM), and the like (not illustrated), and can execute various programs recorded in the non-volatile memory 10c to control each unit of the customer terminal 10 and the printer 51.

The processor 10a may be configured with a single chip, may be configured with a plurality of chips, or may be configured as a system-on-chip (SoC) together with various functional blocks. Further, for example, an application specific integrated circuit (ASIC) may be employed instead of the CPU, or a configuration in which the CPU and the ASIC cooperate with each other may be employed. When each device according to the present embodiment includes a processor, the processor can be implemented in various forms like the processor 10a.

The communication unit 10b includes a communication interface for communicating with an external device according to various communication protocols. The customer terminal 10 can communicate with other devices via the communication unit 10b. The communication unit 10b includes an interface for communicating with various removable memories mounted on the customer terminal 10.

The display 10d is a display device that displays any image. The input unit 10e is a device for a user to perform an input operation, and is implemented by, for example, a touch panel. In the present embodiment, the customer terminal 10 is assumed to be a tablet terminal, and thus, the input unit 10e is mainly assumed to be a touch panel. However, it is a matter of course that a keyboard, mouse, or the like may also be used. In any case, the user as the customer can operate the input unit 10e to input a user's intention while viewing an image or text displayed on the display 10d.

The processor 10a executes a printed matter production program (not illustrated). When the printed matter production program is executed, the processor 10a functions as a reception unit 10a1, a test unit 10a2, and a determination unit 10a3. The reception unit 10a1 has a function of receiving print settings. When placing an order, the customer operates the input unit 10e while viewing the display 10d to designate an image to be formed on a three-dimensional medium, the size of the image, or the like. The reception unit 10a1 generates printing data 10c1 for forming an image on a medium in a designated manner. The printing data 10c1 is associated with order identification information and print settings and recorded in the non-volatile memory 10c. Details of the processing will be described below. The print settings include at least information indicating the size of the image.

In the present embodiment, since the customer performs image designation or the like by using the customer terminal 10, the customer can imagine a three-dimensional medium on which the image is formed, that is, finished printed matter, by using the image displayed on the two-dimensional display 10d. However, it is sometimes difficult to imagine an image formed on a three-dimensional medium. Therefore, in the present embodiment, a test paper sheet on which a test image is printed can be applied to a target medium on which an image is to be formed. As a result, it becomes easier to imagine the image to be formed on the three-dimensional medium.

The test unit 10a2 is a function for performing such a test. In other words, the test unit 10a2 has a function of printing a two-dimensional full-sized test image on a test paper sheet based on print settings before forming an image on a three-dimensional medium. The user as the customer can cut the printed test paper sheet as needed and apply the test paper sheet along the three-dimensional shape. As a result, the customer can easily imagine a state in which the image is formed on the three-dimensional medium. The cutting may be performed automatically when a cutter is provided, or may be performed by the user.

The determination unit 10a3 has a function of determining whether or not the print settings are appropriate by applying the test paper sheet on which the test image is printed to the medium. That is, the determination unit 10a3 controls the input unit 10e to receive an input as to whether or not the printed matter desired by the customer is obtained as a result of applying the test paper sheet to the medium after printing on the test paper sheet. In the present embodiment, the determination unit 10a3 considers that the printed matter desired by the customer is obtained when the customer expresses willingness to make a payment. When it is determined that the printed matter desired by the customer is obtained, the printing data 10c1 is transmitted to the staff terminal 20, and the payment is made.

### 1-2. Configuration of Staff Terminal

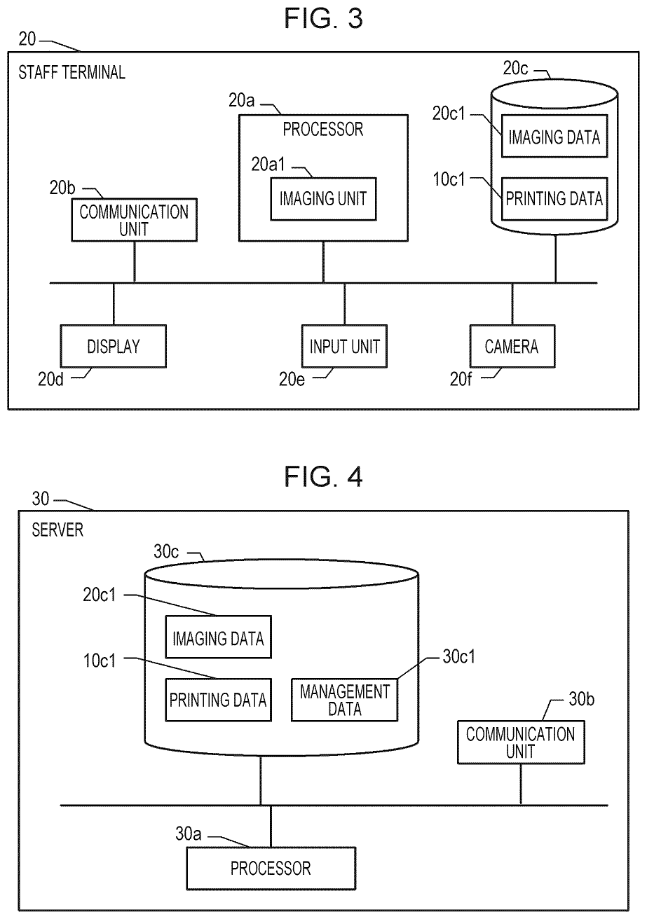

FIG. 3 is a block diagram illustrating a configuration of the staff terminal 20. The staff terminal 20 includes a processor 20a, a communication unit 20b, a non-volatile memory 20c, a display 20d, an input unit 20e, and a camera 20f. The processor 20a includes a CPU, a ROM, a RAM, and the like (not illustrated), and can execute various programs recorded in the non-volatile memory 20c to control each unit of the staff terminal 20 and the printer 52. The printing data 10c1 transmitted from the customer terminal 10 is stored in the non-volatile memory 20c.

The communication unit 20b includes a communication interface for communicating with an external device according to various communication protocols. The staff terminal 20 can communicate with other devices via the communication unit 20b. The communication unit 20b may include an interface for communicating with various removable memories mounted on the staff terminal 20.

The display 20d is a display device that displays any image. The input unit 20e is a device for the user to perform an input operation, and is implemented by, for example, a touch panel. In the present embodiment, the staff terminal 20 is assumed to be a tablet terminal, and thus, the input unit 20e is mainly assumed to be a touch panel. However, it is a matter of course that a keyboard, mouse, ten key, or the like may also be used. In any case, the user as the staff at the storefront can operate the input unit 20e to input a user's intention while viewing an image or text displayed on the display 20d.

The camera 20f includes an imaging element and an imaging optical system (not illustrated), and can capture an image of an imaging target present within a field of view of the imaging optical system according to an operation by the staff. In the present embodiment, the staff terminal 20 is a tablet terminal, and the staff at the storefront can perform imaging of the imaging target by using the camera 20f while adjusting a posture by lifting the staff terminal 20.

In the present embodiment, the staff terminal 20 implemented by a tablet terminal is connected to a point of sales (POS) system (not illustrated). The processor 20a can execute processing for receiving orders and payments, and when a customer's purchase intention is confirmed, the processor 20a causes the POS system to execute payment processing.

Before the payment, the processor 20a executes processing related to production of the ordered printed matter. Therefore, the processor 20a executes the printed matter production program (not illustrated). When the printed matter production program is executed, the processor 20a functions as an imaging unit 20a1. The imaging unit 20a1 has a function of imaging a state in which the test paper sheet on which the test image is printed is applied to the medium. As described above, the customer can print the test image on the test paper sheet to confirm whether or not desired printed matter can be obtained. When it is confirmed that the desired printed matter can be obtained, the customer can inform the staff of his/her purchase intention in a state of applying the test paper sheet to the medium. The staff operates the camera 20f in response to the expression of the purchase intention by the customer, and images the medium to which the test paper sheet is applied. The processor 20a records, in the non-volatile memory 20c, imaging data 20c1 indicating a captured image and identification information of an order produced by forming the image in association with each other. Details of the above processing or work will be described below.

When the staff terminal 20 is instructed to execute the payment processing, the processor 20a transmits the printing data 10c1 and the imaging data 20c1 recorded in the non-volatile memory 20c to the server 30.

### 1-3. Configuration of Server

FIG. 4 is a block diagram illustrating a configuration of the server 30. The server 30 includes a processor 30a, a communication unit 30b, and a non-volatile memory 30c. The processor 30a includes a CPU, a ROM, a RAM, and the like (not illustrated), and can execute various programs recorded in the non-volatile memory 30c to control each unit of the server 30 and each device connected to the network.

The communication unit 30b includes a communication interface for communicating with an external device according to various wired or wireless communication protocols. The server 30 can communicate with other devices via the communication unit 30b. The communication unit 30b may include an interface for communicating with various removable memories mounted on the server 30.

Various types of information are accumulated in the non-volatile memory 30c of the server 30. For example, the printing data 10c1 transmitted from the staff terminal 20 and the imaging data 20c1 associated with the printing data 10c1 are recorded in the non-volatile memory 30c. Further, management data 30c1 is recorded in the non-volatile memory 30c.

The management data 30c1 is information indicating the progress of the order. In the present embodiment, information indicating the progress such as “before printing”, “printing in progress”, or “printing completed” is generated for each order identification information and recorded as the management data 30c1. When the printing data 10c1 is transmitted from the staff terminal 20, the processor 30a generates the management data 30c1 in which the order identification information for the printing data 10c1 is associated with information indicating that a printing status is “before printing”.

When printing of the printing data 10c1 is started by an operation of the printing operator to be described below, information indicating the start of the printing is transmitted from the print control terminal 40, and the processor 30a updates the printing status associated with the order identification information from “before printing” to “printing in progress”. When the printing ends, information indicating the end of the printing is transmitted from the print control terminal 40, and the processor 30a updates the printing status associated with the order identification information from “printing in progress” to “printing completed”. The management data 30c1 can be referenced by the staff terminal 20 or the print control terminal 40 at any timing.

### 1-4. Configuration of Print Control Terminal

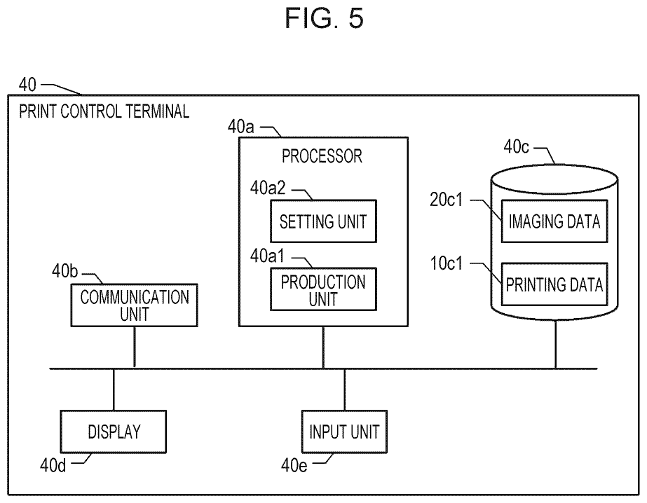

FIG. 5 is a block diagram illustrating a configuration of the print control terminal 40. The print control terminal 40 includes a processor 40a, a communication unit 40b, a non-volatile memory 40c, a display 40d, and an input unit 40e. The processor 40a includes a CPU, a ROM, a RAM, and the like (not illustrated), and can execute various programs recorded in the non-volatile memory 40c to control each unit of the print control terminal 40 and the printers 50a and 50b. The non-volatile memory 40c stores the printing data 10c1 for the order instructed by the printing operator and the imaging data 20c1 corresponding to the printing data.

The communication unit 40b includes a communication interface for communicating with an external device according to various communication protocols. The print control terminal 40 can communicate with other devices via the communication unit 40b. The communication unit 40b includes an interface for communicating with various removable memories mounted on the print control terminal 40.

The display 40d is a display device that displays any image. The input unit 40e is a device for a user to perform an input operation, and is implemented by a keyboard, a mouse, or the like. In the present embodiment, the print control terminal 40 is assumed to be a stationary computer, and thus, the input unit 40e is mainly assumed to be a keyboard or a mouse. However, it is a matter of course that a touch panel or the like may also be used. In any case, the user as the printing operator can operate the input unit 40e to input a user's intention while viewing an image or text displayed on the display 40d.

In the present embodiment, the printer 50a for forming an image on a three-dimensional medium includes the sublimation transfer printer and the press machine for sublimation transfer of an image printed on sublimation transfer paper to a three-dimensional medium as described above. Further, in the present embodiment, a transfer position when transferring the sublimation transfer paper to the three-dimensional medium is adjusted by the printing operator. That is, the position of the image formed on the three-dimensional medium may vary according to the adjustment made by the printing operator. Therefore, the print settings included in the printing data 10c1 for the three-dimensional medium do not include an image formation position on the three-dimensional medium. It is a matter of course that an image printing position on the sublimation transfer paper may be included in the print settings.

Meanwhile, the customer places an order after imagining the position of the image to be formed on the medium in the printed matter. Therefore, printed matter different from the customer's order may be produced when the printing operator forms the image on the three-dimensional medium without grasping the customer's intention. Therefore, in the present embodiment, the customer's intention can be conveyed to the printing operator by the imaging data 20c1.

Specifically, in the present embodiment, the printing operator can display the imaging data 20c1 on the display 40d and set the image formation position while viewing the captured image. The processor 40a executes the printed matter production program (not illustrated) to execute such processing. When the printed matter production program is executed, the processor 40a functions as a production unit 40a1 and a setting unit 40a2.

The production unit 40a1 has a function of forming the image on the three-dimensional medium and producing the printed matter based on the print settings. The production unit 40a1 instructs the printers 50a and 50b to perform printing based on the print settings by referring to the printing data 10c1 of the order instructed by the printing operator using the input unit 40e. The printers 50a and 50b print the image indicated by the printing data 10c1 according to the printing instruction.

When the printed matter is produced by forming the image on the three-dimensional medium, the image is printed on the sublimation transfer paper by the printer 50a. The printing operator applies the sublimation transfer paper to the three-dimensional medium and performs sublimation transfer of the image to the three-dimensional medium by using the press machine. At this time, the position, orientation, and posture of the medium, the position where the sublimation transfer paper is applied, the position where the image is printed on the sublimation transfer paper, and the like are arbitrary. Therefore, the setting unit 40a2 sets the image formation position on the medium based on an imaging result. That is, the setting unit 40a2 controls the display 40d to display the image indicated by the imaging data 20c1.

The image indicated by the imaging data 20c1 is an image captured by the staff in a state where the test paper sheet on which the printing is performed by the customer is applied to the three-dimensional medium. Therefore, the user as the printing operator can imagine a state in which the image is formed on the three-dimensional medium by viewing the image, and can easily grasp the image formation position intended by the customer. The printing operator adjusts, based on the image, the position, orientation, and posture of the medium, the position where the sublimation transfer paper is applied, and the like, and sets the image formation position. Then, pressing is performed using the press machine in such a way that the image is formed at the formation position. With the above-described operations, printed matter in which an image is formed on a three-dimensional medium is produced.

### 2. Printed Matter Production Processing

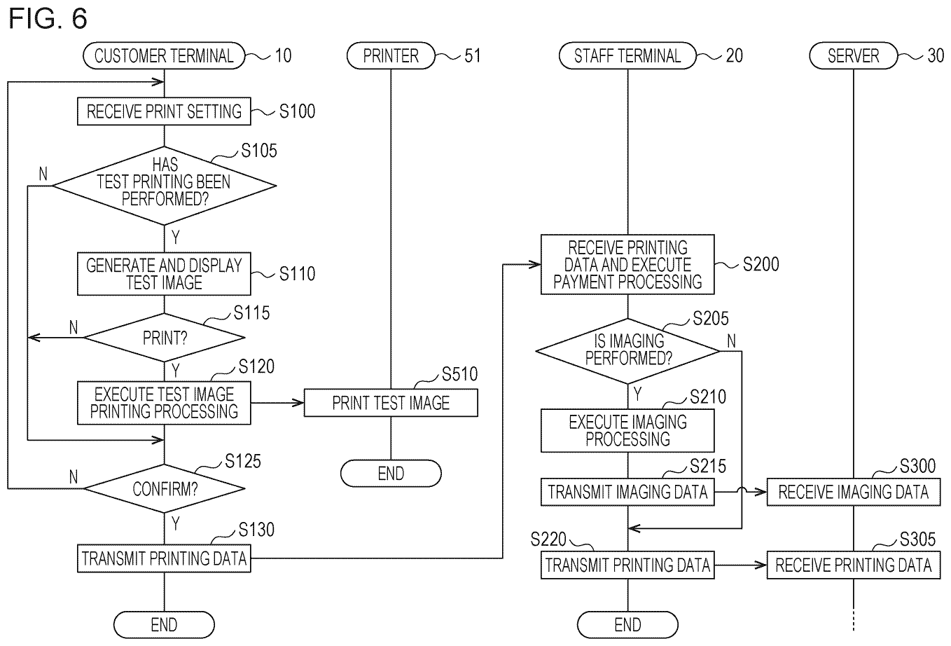

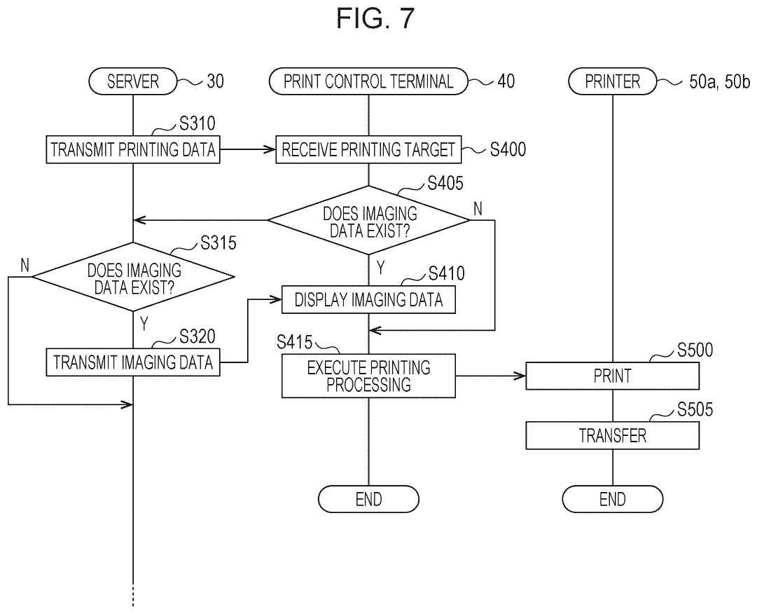

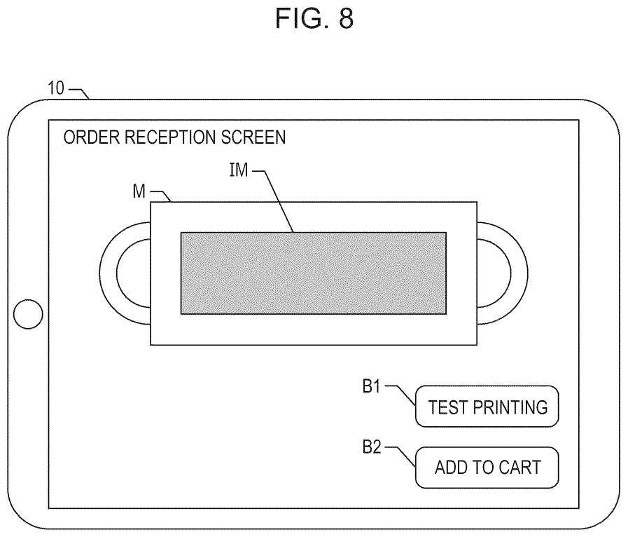

FIGS. 6 and 7 are sequence diagrams of printed matter production processing. When the customer starts to place an order for printed matter at the storefront, the printed matter production processing for the order is started. When the customer starts to place an order, the processor 10a receives the print settings by using the function of the reception unit 10a1 (step S100). Specifically, the customer selects a medium on which a desired image is to be formed while referring to samples of media in the store or images of media displayed on the display 10d. Further, the customer selects an image stored in a removable memory or the like and transfers the image to the customer terminal 10.

The medium includes a three-dimensional medium and a two-dimensional medium, and a single customer may order formation of an image on a plurality of media. When an image is formed on a two-dimensional medium, the customer inputs the type of medium, the image as a printing target (a file name or the like), the size of the image, and the number of copies as the print settings. When an image is formed on a three-dimensional medium, the customer inputs the type of medium, the image to be formed (a file name or the like), the size of the image, and the number of printed matters as the print settings.

The reception unit 10a1 associates the image with the print settings input by the customer, and stores the image as the printing data 10c1 in the non-volatile memory 10c. FIG. 8 illustrates an order reception screen displayed on the display 10d of the customer terminal 10 when determining the size of an image to be formed on a three-dimensional medium. An unfolded image of a medium M is displayed on the order reception screen. In the example illustrated in FIG. 8, the medium M is a mug.

The customer operates the input unit 10e to trim, enlarge, or reduce an image IM selected by the customer to determine the size, and overlay the image IM on the medium M. By such processing, the customer can consider order details while considering how the image is to be overlaid on the three-dimensional medium, and can determine the size of the image IM. The customer also inputs the above-described print settings on a screen other than the screen of FIG. 8. The reception unit 10a1 associates the image with the print settings input by the customer, and stores the image as the printing data 10c1 in the non-volatile memory 10c.

Next, the processor 10a determines whether or not execution of the test printing has been instructed by the function of the test unit 10a2 (step S105). An instruction section for instructing execution of the test printing is displayed on the order reception screen for the three-dimensional medium, for example, like a button B1 in FIG. 8. When the instruction section is operated, the test unit 10a2 determines that execution of the test printing has been instructed.

When it is determined in step S105 that execution of the test printing has been instructed, the test unit 10a2 generates and displays a test image (step S110). The test image is a two-dimensional full-sized image of the image to be formed on the three-dimensional medium. In the example of FIG. 8, the image is formed on a curved surface, which is a side surface of the mug, and the image is transferred to the curved surface by the sublimation transfer paper. Therefore, the image selected on the order reception screen illustrated in FIG. 8 is a two-dimensional image. Therefore, in this example, the test image is the same as the image printed on the sublimation transfer paper. That is, the test unit 10a2 generates the test image for printing the image in an image size indicated by the printing data 10c1.

Meanwhile, in a case where an image is formed on a surface with a more complicated shape or on a plurality of surfaces, it is sufficient if the test image is generated in such a way that it is easier to imagine a finished product by applying the image printed for test to the three-dimensional medium. For example, the test image can be an image obtained by projecting an image for each surface of the three-dimensional medium onto a certain surface, or an unfolded image for printing the images of the respective surfaces on a sheet of printing paper. In either case, the test paper sheet is used to imagine the finished printed matter by being applied to the three-dimensional medium. Therefore, the test unit 10a2 generates the test image having the same size (the same print region and resolution) as the image to be formed on the three-dimensional medium.

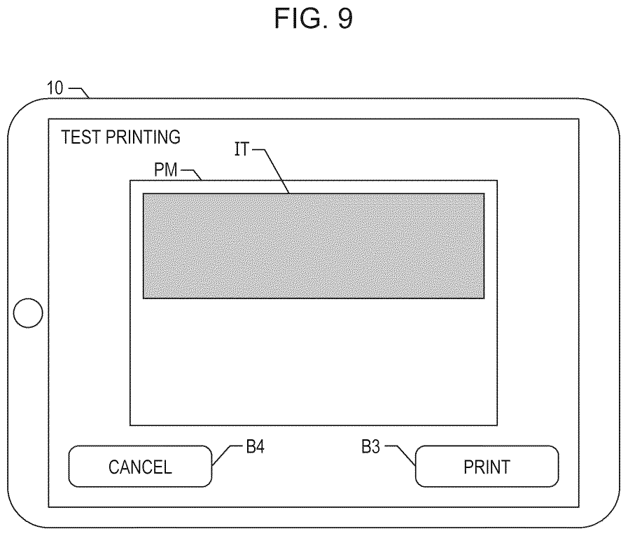

Once the test image is generated, the test unit 10a2 controls the display 10d to display the test image. Further, the test unit 10a2 controls the display 10d to display a button for instructing whether or not to print the test image. FIG. 9 illustrates an example of a screen for test printing. In the screen illustrated in FIG. 9, a test image IT is displayed in a state where the image IM as a printing target in FIG. 8 is arranged on a test paper sheet PM. In the example illustrated in FIG. 9, a button B3 for instructing execution of the test printing and a button B4 for instructing cancellation are displayed.

Next, the processor 10a determines whether or not printing has been instructed by the function of the test unit 10a2 (step S115). In the example illustrated in FIG. 9, the test unit 10a2 determines that the printing has been instructed when the customer has operated the button B3. When the customer has operated the button B4, the test unit 10a2 does not determine that the printing has been instructed.

When it is determined in step S115 that the printing has been instructed, the test unit 10a2 performs printing processing for the test image (step S120). That is, the test unit 10a2 generates data for printing the test image on the test paper sheet in the image size indicated by the printing data 10c1 and transmits the data to the printer 51. Once the printer 51 receives the data, the printer 51 prints the test image on the test paper sheet (step S510). It is sufficient if the test paper sheet is any paper sheet that can be applied to a three-dimensional medium, and arbitrary printing paper can be used as the test paper sheet. When the printing has been performed in step S120, or when it is not determined in step S115 that the printing has been performed, the processor 10a returns to the screen illustrated in FIG. 8 and continues processing.

When step S120 is executed, the test paper sheet such as the displayed test paper sheet PM in FIG. 9 is obtained. When the test paper sheet is obtained, for example, the customer asks the staff of the store to cut the test paper sheet in such a way that the test image remains. The customer applies the cut test paper sheet to the three-dimensional medium and confirms whether or not a state in which the image is applied to the three-dimensional medium is as imagined. When the state is not as imagined, the customer adjusts the position of the test paper sheet to confirm whether or not the state is as imagined. When the state is still not as imagined, the print settings are made again. In other words, the customer can obtain a preview of the finished product that can be obtained with the current print settings by performing the test to view a state in which the image is applied to the medium. Then, the customer changes the print settings according to the preview of the finished product in such a way as to obtain a desired finished product as necessary.

When it is not determined in step S105 that execution of the test printing has been instructed, when the printing has not been instructed in step S115, or when step S120 has been performed, the processor 10a determines whether or not the customer has confirmed the order by the function of the determination unit 10a3 (step S125). That is, when the test image is printed and the order is confirmed, the determination unit 10a3 determines that the print settings are appropriate as the customer imagined as a result of the test in which the test paper sheet is applied to the three-dimensional medium. In the screen illustrated in FIG. 8, the button B2 labeled “add to cart” is a button for instructing order confirmation. When the order is confirmed before the test image is printed, capturing of the test image to be described below, adjustment of the image formation position based on the imaging result, and the like are not performed. For example, when printing is performed on a two-dimensional medium, the order is confirmed in a state in which the test image is not printed. Further, when the image is formed on a three-dimensional medium, the printing of the test image may be omitted according to the customer's will. In this case, the image formation position on the three-dimensional medium may be determined based on the printing data 10c1. For example, the printing data 10c1 includes settings such as the use of paper of a predetermined size as the sublimation transfer paper for transfer to a three-dimensional medium, and a predetermined region on which the printing is to be performed. With this configuration, the printing operator can produce printed matter of a three-dimensional medium ordered by the customer by arranging the sublimation transfer paper at a predetermined position on the three-dimensional medium and performing a transfer operation.

When it is not determined in step S125 that the customer has confirmed the order, the processor 10a repeats the processing from step S100. On the other hand, when it is determined in step S125 that the customer has confirmed the order, the determination unit 10a3 transmits the printing data 10c1 generated in step S100 to the staff terminal 20 (step S130).

Once the order is confirmed and the printing data 10c1 is transmitted to the staff terminal 20, the processor 20a receives the printing data 10c1 and executes the payment processing (step S200). That is, the processor 20a receives the printing data 10c1 via the communication unit 20b and stores the printing data 10c1 in the non-volatile memory 20c. The processor 20a also communicates with the POS system (not illustrated) via the communication unit 20b to receive the payment for the order from the customer.

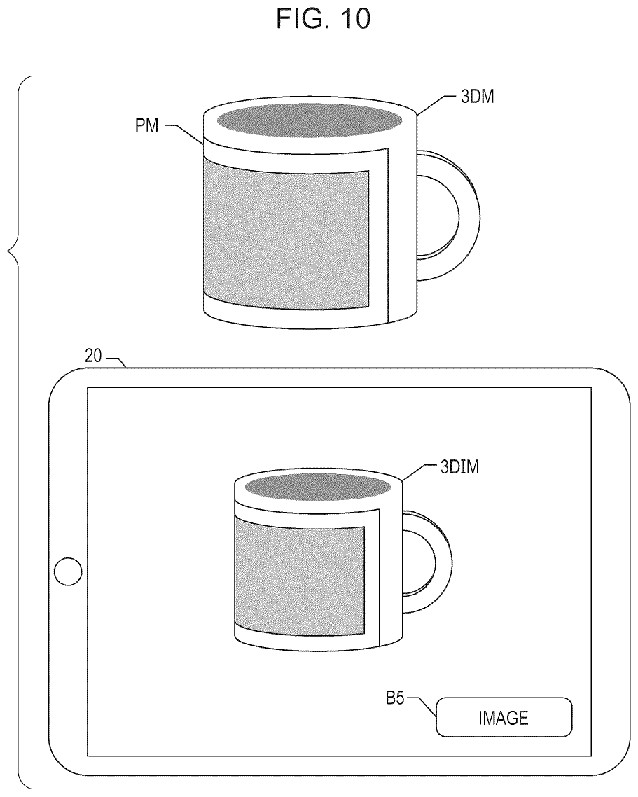

Next, the processor 20a determines whether or not execution of imaging has been instructed by the function of the imaging unit 20a1 (step S205). Specifically, the imaging unit 20a1 controls the display 20d to display an instruction section for instructing execution of imaging. When the staff uses the input unit 20e to give the instruction by the instruction section, the imaging unit 20a1 determines that execution of imaging has been instructed. When it is determined in step S205 that execution of imaging has been instructed, the processor 20a executes imaging processing by the function of the imaging unit 20a1 (step S210). That is, the imaging unit 20a1 activates the camera 20f and allows the staff to image a state in which a test paper sheet is applied to a three-dimensional medium. FIG. 10 is a diagram for describing how the imaging is performed. FIG. 10 illustrates a state in which the test paper sheet PM is applied to a three-dimensional medium 3DM, and further illustrates a state in which the medium 3DM and the test paper sheet PM are within a field of view of the camera 20f of the staff terminal 20. The display 20d of the staff terminal 20 displays an image 3DIM showing the medium 3DM to which the test paper sheet PM is applied.

Further, an imaging button B5 is displayed on the display 20d, and when the staff operates the imaging button B5 to instruct imaging, the medium 3DM to which the test paper sheet PM is applied is imaged. When the imaging processing is executed, the imaging data 20c1 indicating the captured image is generated and stored in the non-volatile memory 20c in association with the identification information of the order for which payment has been made. In addition, the processor 20a transmits the imaging data 20c1 to the server 30 by the function of the imaging unit 20a1 (step S215). The processor 30a of the server 30 receives the imaging data 20c1 via the communication unit 30b and stores the imaging data 20c1 in the non-volatile memory 30c (step S300). When the imaging is performed, the captured image may be displayed instead of or together with the image of the medium M illustrated in FIG. 8.

When it is not determined in step S205 that execution of imaging has been instructed, or when step S215 has been executed, the processor 20a transmits the printing data 10c1 to the server 30 by the function of the imaging unit 20a1 (step S220). The processor 30a of the server 30 receives the printing data 10c1 via the communication unit 30b and stores the printing data 10c1 in the non-volatile memory 30c (step S305).

When the order is confirmed, the printing operator produces the ordered printed matter in the backyard. At this time, the printing operator operates the print control terminal 40 to instruct the start of printing. When the start of printing is instructed, the processor 40a of the print control terminal 40 receives designation of a printing target (step S400). That is, the processor 40a allows the printing operator to designate an order to be processed. Specifically, the processor 40a inquires of the server 30 about an order before printing. The processor 30a of the server 30 specifies the printing data 10c1 of the order before printing by referring to the management data 30c1 in the non-volatile memory 30c, and transmits the printing data 10c1 to the print control terminal 40 (step S310). The processor 40a receives the printing data 10c1 and displays the order before printing on the display 40d in a selectable manner. A display mode is not limited, and for example, pieces of order identification information may be displayed as a list, or images as printing targets may be displayed as a list. In any case, the printing operator operates the input unit 40e to designate the printing target.

When the printing target is designated, the processor 40a determines whether or not the imaging data 20c1 corresponding to the printing data 10c1 as a printing target exist, by the function of the setting unit 40a2 (step S405). Specifically, the setting unit 40a2 inquires of the server 30 about whether or not the imaging data 20c1 associated with the same identification information as the identification information associated with the printing data 10c1 as the printing target received in step S400 exist. In response to the inquiry, the server 30 determines whether or not the imaging data 20c1 associated with the identification information exists by referring to the non-volatile memory 30c based on the identification information (step S315). When it is determined in step S315 that the imaging data 20c1 associated with the identification information exists, the processor 30a transmits the imaging data 20c1 to the print control terminal 40 (step S320). Then, the setting unit 40a2 receives the imaging data 20c1 transmitted in step S315, and the setting unit 40a2 displays the imaging data 20c1 (step S410). Specifically, the setting unit 40a2 controls the display 20d to display the image indicated by the imaging data 20c1 in such a way that the printing operator can set the transfer position of the image on the three-dimensional medium 3DM. Here, it is sufficient if the image indicated by the imaging data 20c1 is displayed, and the image may be displayed in various modes. For example, an example in which an image as displayed on the display 20d of the staff terminal 20 in FIG. 10 is displayed is assumed. When the printing target does not include the printed matter that is a three-dimensional medium, the display of the imaging data is skipped by the determination in step S405, and the image indicated by the printing data 10c1 may be displayed as a preview instead of the imaging data 20c1.

When it is determined in step S315 that the imaging data 20c1 corresponding to the printing data 10c1 as the printing target does not exist in the non-volatile memory 30c, the server 30 skips step S320. In this case, the processor 40a skips step S410 without determining in step S405 that the imaging data 20c1 corresponding to the printing data 10c1 as the printing target exists. Then, the processor 40a executes the printing processing by the function of the production unit 40a1 (step S415). That is, the production unit 40a1 specifies the print settings by referring to the printing data 10c1 as the printing target received in step S400. Then, the production unit 40a1 generates data for printing the image included in the printing data 10c1 according to the print settings, and transmits the data to the printers 50a and 50b. Once the printers 50a and 50b receive the data, printing is performed (step S500).

When the printing target includes the printed matter of the three-dimensional medium, the image is printed on the sublimation transfer paper. When the imaging data 20c1 corresponding to the printing data 10c1 as the printing target exists, the image indicated by the imaging data 20c1 is displayed on the display 40d. Therefore, the printing operator sets the transfer position by referring to the image displayed on the display 40d. That is, the printing operator sets the three-dimensional medium in the press machine and adjusts the transfer position of the sublimation transfer paper by referring to the image displayed on the display 40d. When the transfer position is adjusted to be equivalent to the image, the printing operator operates the press machine to transfer the image and form the image on the three-dimensional medium (step S505). When the imaging data 20c1 corresponding to the printing data 10c1 as the printing target does not exist, the printing operator sets the three-dimensional medium in the press machine and transfers the image in a state in which a predetermined position on the sublimation transfer paper matches with a predetermined position on the three-dimensional medium, thereby forming the image on the three-dimensional medium. When the printing target does not include the printed matter that is a three-dimensional medium, step S505 may be skipped.

### 3. Other Embodiments

The above-described embodiment is merely an example for carrying out the present disclosure, and various other embodiments can be employed. Further, the types of printers illustrated in the above-described embodiment are merely examples, and printers capable of performing printing on a three-dimensional medium may also be employed. The type of printer for forming an image on a two-dimensional medium is also not limited.

Further, the device configuration of the printed matter production system is not limited to the configuration illustrated in FIG. 1. For example, the device present in each of the store and the backyard may have a configuration different from the configuration illustrated in FIG. 1. Further, each terminal illustrated in FIG. 1 may be implemented by a smaller number of terminals sharing the functions, or a larger number of terminals. For example, the customer terminal 10 and the staff terminal 20 may be the same terminal, and the server 30 and the print control terminal 40 may be the same terminal. Furthermore, each terminal may be implemented by a larger number of terminals, for example, the server 30 may be a cloud server.

Furthermore, when the test image is printed on the test paper sheet, the periphery of the test image may be colored. For example, when the test unit 10a2 of the processor 10a prints the test image, the color of the three-dimensional medium may be printed on the periphery of the test image. That is, by coloring the periphery of the test image in the same color as the ground color of the three-dimensional medium, it is possible to create a preview closer to the actual printed matter. With the above configuration, even when the test paper sheet is not cut right at the edge of the test image, there is no color different from the color of the medium in the periphery of the test image, and thus, it becomes easier to create a preview close to the actual printed matter. The color of the medium may be specified by various methods. For example, pixel values may be defined in advance for each medium type and color variation and used as the color of the medium, the color of the medium may be specified by scanning or colorimetry, or the color of the medium may be specified by the user.

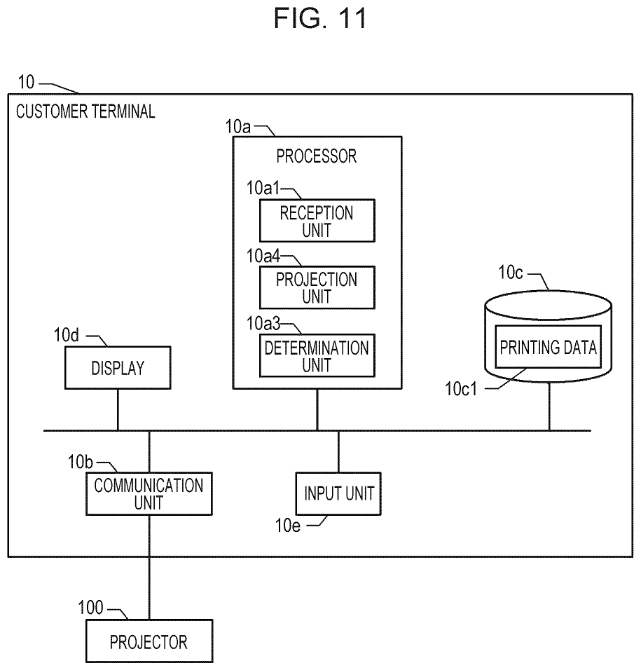

Furthermore, the test may be performed without using the test paper sheet. That is, when the test image can be overlaid on and applied to a three-dimensional medium, the test can be performed. Therefore, various devices that can overlay the test image on a three-dimensional medium may be used for the test. FIG. 11 is a diagram illustrating a configuration for performing the test by projecting the test image onto a three-dimensional medium by using a projector 100. This embodiment can be implemented by connecting the projector 100 to the customer terminal 10 in the above-described embodiment.

However, in this configuration, printing on the test paper sheet is not performed, and projection by the projector 100 is performed instead. That is, before forming an image on a three-dimensional medium, the processor 10a projects the image onto the medium based on the print settings by the function of a projection unit 10a4. Specifically, the projection unit 10a4 generates an image to be projected in the same size as the size of the image indicated by the print settings included in the printing data 10c1. That is, the number of pixels of the image and the size in which the image of the number of pixels is projected onto the three-dimensional medium are measured in advance, and an optical system of the projector 100 is adjusted and fixed in such a way that the projection is performed with the same size as the measurement result.

The projection unit 10a4 controls the projector 100 to project the generated image onto the three-dimensional medium. Since the image is projected onto the three-dimensional medium, a test image is generated and projected in such a way that the projected image looks the same as the image formed on the three-dimensional medium. Such processing can be implemented in various ways. For example, the test image is generated in such a way as to look the same as when the three-dimensional medium is viewed from a particular plane. Therefore, the projector 100 and a position where the medium as a projection target is set are determined in advance, and a projection position of the image on the medium can be changed by changing the posture of the medium.

For example, in a case of a mug as illustrated in FIG. 10, the mug is mounted at a specific position as the projection target of the projector 100, and rotated without changing the position to change the projection position of the image on the medium. Furthermore, when the mug as illustrated in FIG. 10 is viewed from the side, the image is visually distorted, and the degree of distortion varies depending on the position. For example, the distortion of the image is small at the central portion of a side surface, but the distortion of the image increases as the distance from the central portion of the side surface increases and the distance from the right or left edge of the side surface decreases. Therefore, the projector 100 specifies the degree of distortion of the image in advance based on a relative positional relationship between the projector 100 and the medium, and generates a distorted image as the test image.

By projecting such a test image onto the medium by the projector 100, the customer can view a state similar to a state in which the image is formed on the side surface of the mug. Therefore, the customer can change the posture of the medium or correct the size of the image to input the print settings that match the customer's imagination. Even with the above configuration, the projection result that matches the customer's imagination is imaged by the staff or the like, and is referred to by the printing operator before printing. With the above configuration, the user can easily imagine finished printed matter.

In the above-described embodiment, the posture of the three-dimensional medium is changed, but the position of the three-dimensional medium may also be changed. For example, the position of the three-dimensional medium may be adjusted in such a way that the projected image is overlaid on the three-dimensional medium while the projector 100 is performing projection. It is a matter of course that at least one of the position or the posture of the three-dimensional medium may be changed with the adjustment of the optical system by the projector 100.

The reception unit only needs to be able to receive the print settings. That is, it is sufficient if information regarding settings necessary for forming an image on three-dimensional printed matter can be received. The print settings may include various types of information necessary for image formation, and various settings other than those in the above-described embodiment may be possible. For example, various types of information such as a print image quality, a print speed, the type of ink to be used, and an image formation method may be received as the print settings.

It is sufficient if the production unit can form an image on a three-dimensional medium and produce printed matter based on the print settings. The image may be formed on the medium in a manner in which the image is printed directly on the medium by a printer, or the image is printed on a print medium by a printer and then transferred by the user as a printing vendor. That is, the image may be formed on the medium in an arbitrary manner. Meanwhile, although the manner in which an image is formed on a medium is arbitrary, printing is used at any one stage of the process. Therefore, settings for forming an image on a medium are called print settings. Further, a medium produced by image formation is called printed matter.

It is sufficient if the medium is any object on which an image can be formed, and the medium is not limited to the examples in the above-described embodiment. For example, various objects such as can bodies, signboards, photo frames, and objects manufactured with a 3D printer may be used as the medium. It is a matter of course that a material of the medium is not limited. The three-dimensional medium is not an object that exists in one or two dimensions, but an object that has a finite size in three dimensions. The image may be formed on any surface of the medium, but the test by the test unit is particularly useful for a medium on which an image is formed on a region that includes a curved surface or a step, that is, a region other than a flat region.

It is sufficient if the test unit can perform the test in such a way that a three-dimensional medium on which an image is formed can be imagined before the image is actually formed on the medium. However, actually printing an image on a medium corresponds to actual production, and thus is not performed as the test. In the test, before forming an image on a medium, a two-dimensional test image of the image is printed on the test paper sheet based on the print settings. Further, the test is implemented by printing a full-sized image on the test paper sheet.

Since the test paper sheet is a print medium having a two-dimensional surface and is printed in a two-dimensional state, a two-dimensional test image of an image to be formed on a three-dimensional medium is printed. It is sufficient if the test image is two-dimensional, and the test image may be the same as the image to be formed on the three-dimensional medium or may be a transformed image. The former includes a mode in which an image is formed by, for example, printing an image defined in a two-dimensional plane on a curved surface of a medium. The latter includes a mode in which an image is formed by, for example, printing or transferring an image defined in a two-dimensional plane on or to a surface of a medium having a step or a complicated shape through transformation, processing, or the like.

The test image is a full-sized image of an image to be formed on a medium. That is, when the test image is printed on the test paper sheet, it is sufficient if the size of the test image printed on the test paper sheet and the size of the image formed on the medium are the same or substantially the same as each other. Alternatively, when the test image is projected onto the medium, it is sufficient if the size of the projected test image on the medium and the size of the image formed on the medium are the same or substantially the same as each other. As a result, it is sufficient if the user can imagine a state after the image is formed on the three-dimensional medium by applying the test paper sheet to the medium. The user can imagine a state after the image is formed on the three-dimensional medium by using the medium on which the image is finally formed by the production unit and the test image, or the user can imagine a state after the image is formed on the three-dimensional medium by using a test medium different from the medium on which the image is finally formed by the production unit, and the test image. In this case, the test medium may be a medium prepared for testing, or a sample prepared at the storefront to help the customer in selecting the medium. Either way, the medium and the test medium may be of the same type.

The imaging unit only needs to be able to image a state in which the test paper sheet on which the test image is printed is applied to a medium. For example, the imaging unit may allow the customer or staff to perform imaging. The test paper sheet may be applied to a medium in various manners. As described above, when a circumference of the medium is a curved surface equivalent to a cylinder, it is sufficient if the test paper sheet is applied along the curved surface. When the medium has a more complicated shape, the test paper sheet may be cut to fit the shape of the medium, for example, a plurality of test paper sheets may be applied to a plurality of surfaces of the medium. It is a matter of course that an adhesive or the like may be used to apply the test paper sheet to the medium.

The setting unit only needs to be able to set an image formation position on a medium based on an imaging result. The setting of the image formation position may be performed by the user as the printing operator who performs printing on the medium as in the above-described embodiment, may be performed by another person, or may be performed by a processor. When implemented by the processor, the processor specifies the positions of the medium and the image from the imaging result, and makes the print settings in such a way that the position of the image in the imaging result becomes the printing position. By doing so, the user need not make at least some of the print settings. However, the user may determine whether or not the print settings made by the processor are acceptable, correct the print settings as necessary, and confirm the print settings. Then, the production unit prints the image on the sublimation transfer paper in such a way that the image is formed at the position that can be read from the imaging result, or directly forms the image at the position that can be read from the imaging result.

The determination unit may determine whether or not the print settings are appropriate by applying the test paper sheet on which the test image is printed to a medium. That is, when the test paper sheet is applied to the medium, the user can easily imagine the image formed on the medium from a relationship between the test paper sheet and the medium, and determine whether or not printed matter imagined by the user can be produced. When the user makes determination, the determination unit receives the determination as to whether or not the medium is appropriate. As in the above-described embodiment, it may be possible to select whether or not to set an image formation position by printing and imaging the test image or when producing printed matter of a three-dimensional medium, printing and imaging of the test image may be performed. When the user is accustomed to forming an image on a three-dimensional medium and thus determines that printing of the test image is unnecessary, the printed matter production system may accept the omission of printing of the test image and form the image on the three-dimensional medium without printing the test image. Further, when the user determines that a default position is suitable as the formation position as a result of applying the test image to the medium, and thus no change is necessary, the printed matter production system may accept the omission of printing of the test image, and the imaging may be omitted. In this case, the image is formed on the three-dimensional medium at the default formation position. In a case in which a two-dimensional medium can also be selected in addition to a three-dimensional medium as a final printing target, when the user selects a three-dimensional medium as the final product, printing and imaging of the test image can be performed, and when the user selects a two-dimensional medium as the final product, printing and imaging of the test image may not be able to be performed.

Furthermore, the present disclosure can also be applied as a computer-executable program or method. The above-described system, program, and method may be implemented as a single device or may be implemented by using components included in a plurality of devices, and each element may be provided in a device different from the above-described device, and thus the system, program, and method include various aspects. The present disclosure can be appropriately modified. For example, the present disclosure is partially implemented by software and partially implemented by hardware. Furthermore, the present disclosure can also be applied as a recording medium of a program that controls the system. It is a matter of course that the recording medium of the program may be a magnetic recording medium, a semiconductor memory, or any recording medium to be developed in the future. For example, the camera may be a part of the customer terminal or staff terminal, or may be a general camera independent of the customer terminal and staff terminal. In a case of a general camera, an imaging result can be transferred to the customer terminal or staff terminal by using a memory card or the like.

What is claimed is:

1. A printed matter production system comprising:
a reception unit that receives print settings;
a production unit that controls a production device to form an image on a three-dimensional medium and produce printed matter based on the print settings; and
a test unit that performs a test in which the image is applied to the medium or a three-dimensional test medium corresponding to the medium based on the print settings before forming the image on the medium to make a user determine whether or not the print settings are appropriate,
wherein the test is performed without performing printing on the medium and the test medium.

2. The printed matter production system according to claim 1, wherein the test unit prints a two-dimensional test image of the image on a test paper sheet by using a printing device, and
the test unit makes the user determine whether or not the print settings are appropriate in a manner in which the user applies the test paper sheet on which the test image is printed to the medium or the test medium corresponding to the medium.

3. The printed matter production system according to claim 2, further comprising:
an imaging unit that causes an imaging device to image a state in which the test paper sheet on which the test image is printed is applied to the medium or the test medium corresponding to the medium; and
a setting unit that sets a formation position of the image on the medium to a position based on an imaging result.

4. The printed matter production system according to claim 2, wherein the test unit prints a color of the medium in a periphery of the test image.

5. The printed matter production system according to claim 2, wherein the test unit prints the test image in same dimensions as when the production unit produces the printed matter with the image.

6. The printed matter production system according to claim 1, wherein the test unit projects the image onto the medium or the test medium corresponding to the medium based on the print settings by using a projection device to make the user determine whether or not the print settings are appropriate.

7. The printed matter production system according to claim 6, further comprising:
an imaging unit that causes an imaging device to image the medium onto which the image is projected; and
a setting unit that sets a formation position of the image on the medium based on an imaging result,
wherein the projection device projects the image onto the medium or the test medium of which at least one of a position or a posture is changeable.

8. The printed matter production system according to claim 6, wherein the test unit projects the image in same dimensions as when the production unit produces the printed matter.

9. A printing method comprising:
receiving print settings;
performing a test in which an image is applied to a three-dimensional medium or a three-dimensional test medium corresponding to the medium based on the print settings to make a user determine whether or not the print settings are appropriate; and
forming the image on the medium based on the print settings according to a determination result indicating that the print settings are appropriate.

10. A non-transitory computer-readable storage medium storing a printed matter production program that causes a computer to function as:
a reception unit that receives print settings;
a determination unit that makes a user determine whether or not the print settings are appropriate by a test in which an image is applied to a three-dimensional medium or a three-dimensional test medium corresponding to the medium based on the print settings; and
a production unit that causes a production device to form the image on the medium and produce printed matter based on the print settings according to a determination result indicating that the print settings are appropriate.
